(19) United States
(12) Patent Application Publication
(10) Pub. No.: US 2004/0212996 A1
(43) Pub. Date: Oct. 28, 2004

(54) Ring lamp

(76) Inventor: Friedrich Burckhardt, Germerswang (DE)

Correspondence Address: HOFFMAN, WASSON & GITLER, P.C., Suite 522, 2361 Jefferson Davis Highway, Arlington, VA, 22202, US

(21) Appl. No.: 10/428,155

(22) Filed: May 2, 2003

(51) Int. Cl. F21V 21/00

(52) U.S. Cl. 362/249

(57) ABSTRACT

The invention refers to a novel ring lamp for being used as a lens of a camera, especially a digital camera, comprising an annular support which can be fastened to the lens, and with an annular light source arranged on the support.

This invention refers to ring lamps according to the introductory part of patent claim 1 or patent claim 23.

Ring lamps of this type are known as flash lights for cameras resp. photographic apparatuses.

It is an object of this invention to provide a ring lamp which results in an optimum illumination of an image field to be covered or alternatively to be imaged by a camera with a minimum of energy consumption.

For solving this object the invention proposes a ring lamp with the features of patent claim 1 or patent claim 23.

The light source of a ring lamp according to the invention is formed by a plurality of light emitting diodes (LEDs) with high illumination power, and at the same time low energy consumption and low heat generation. By using such light sources it is also possible to provide the ring lamp with a longer period of illumination of the image field directly at the lens of the camera.

Furthermore, it is possible to supply the ring lamp from a battery driven control and supply unit, which has smaller dimensions and less weight, and allows optimum mobility.

The light emitting diodes provided on an annular circuit board can be altered by means of a conical focussing ring in their orientation with reference to the axis of the ring lamp in order to concentrate or alternatively to focus the light emitting from these diodes within an area to be illuminated. Focussing the light emitting diodes for example is enabled by altering the circuit board or circuit board arrangement on which the diodes are provided in view of their orientation relative to the axis of the ring lamp.

Further embodiments of the invention are the subject of subclaims. In the following, the invention will be explained together with the drawings by describing special embodiments in more detail. The drawings show:

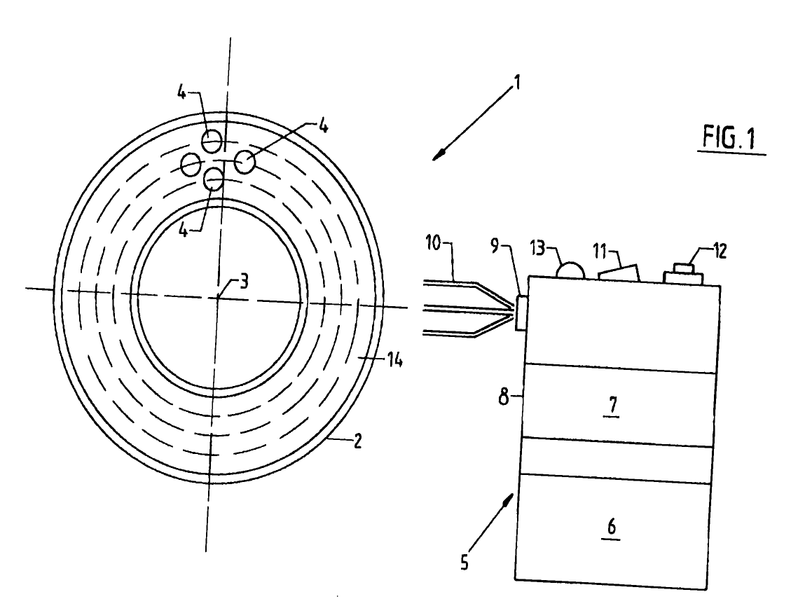

FIG. 1 in a simplified representation and in plan view a ring lamp according to the invention with associated triggering means for the light diodes;

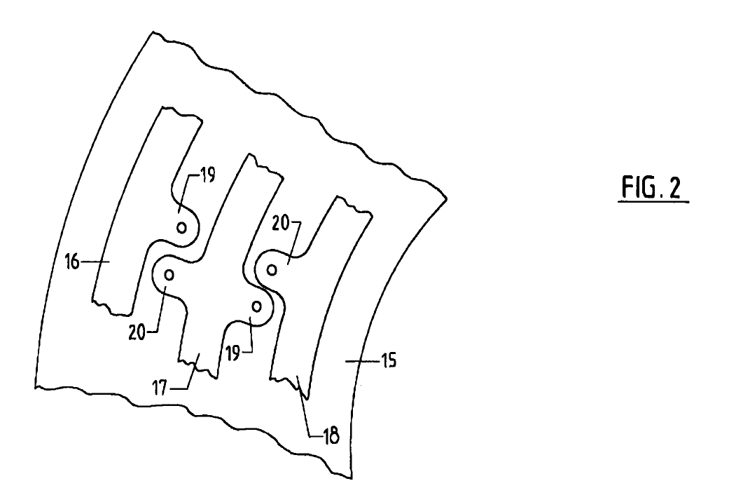

FIG. 2 in a more detailed and in an enlarged representation a plan view of a circuit board for the light diodes;

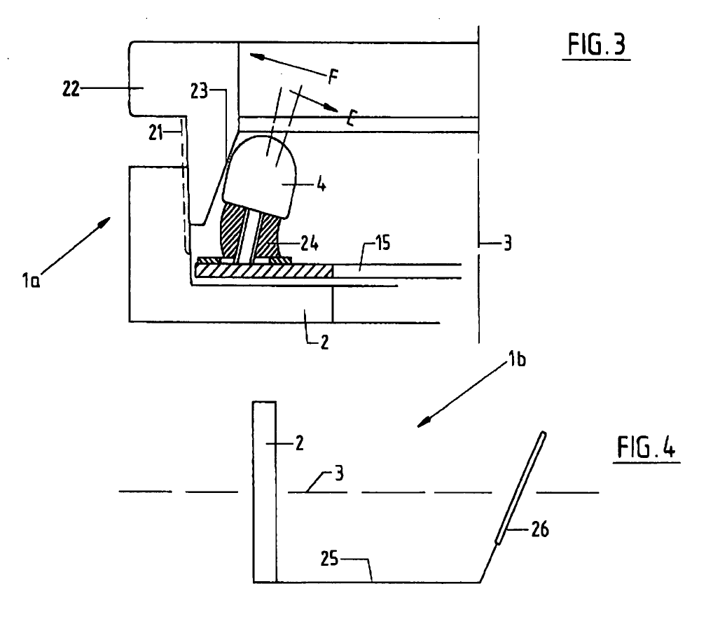

FIG. 3 in a simplified representation a partial cross-section through a single-line ring lamp arrangement together with a focussing conus;

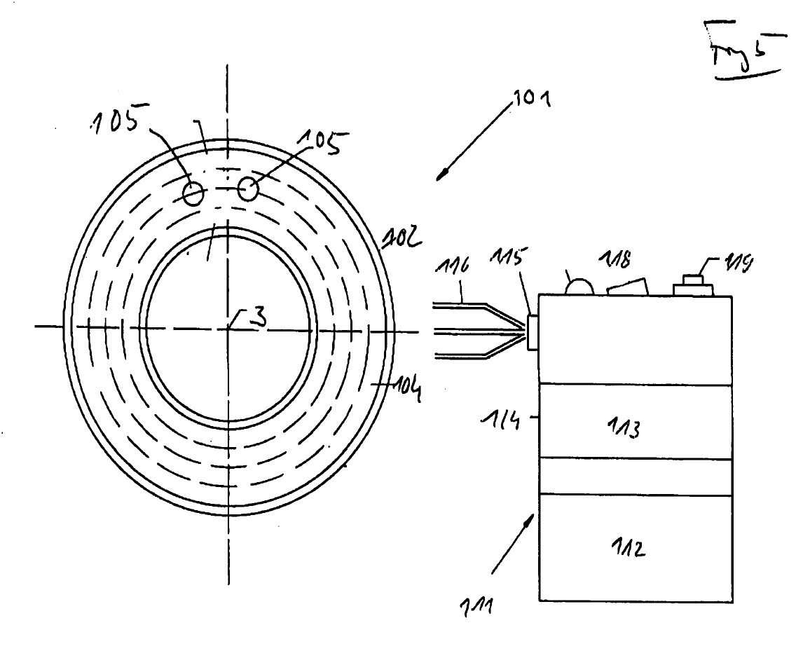

FIG. 4 in a simplified manner an ring lamp with a mirror;

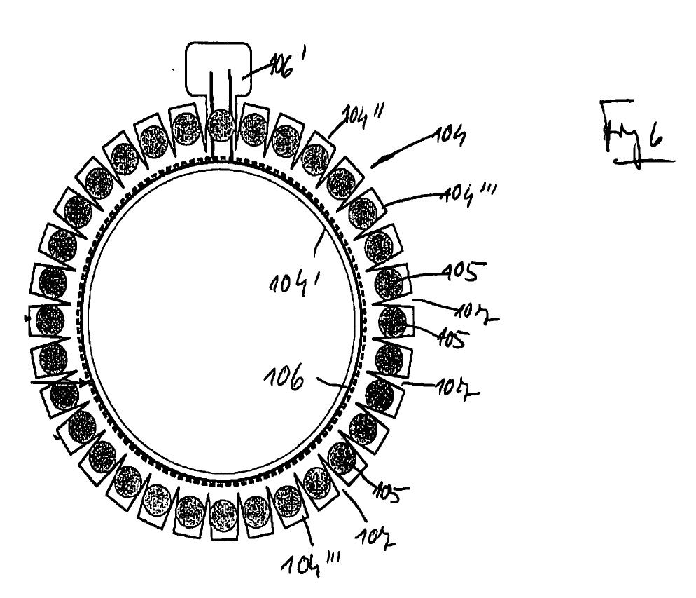

FIG. 5 in a simplified manner a plan view on a ring lamp according to a further embodiment of the invention with associated triggering means for the light diodes;

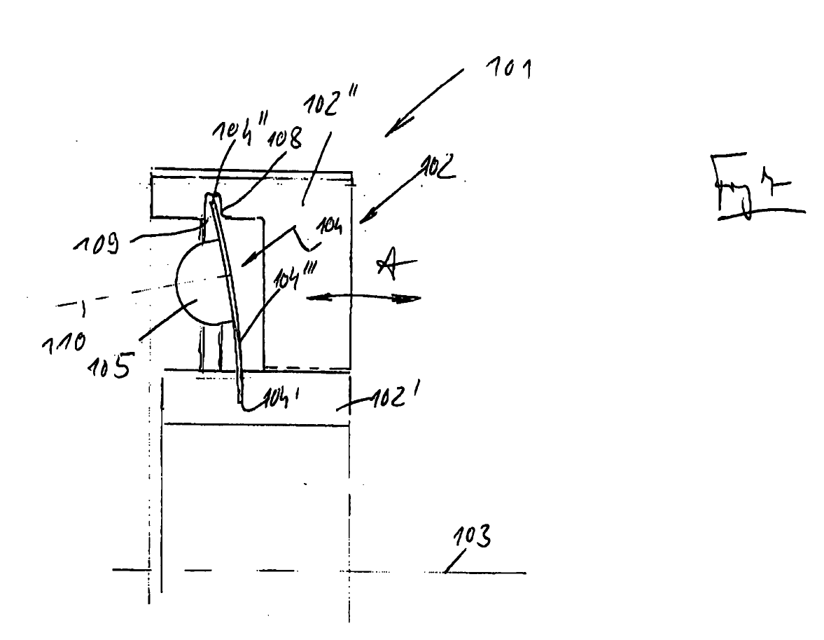

FIG. 6 in detained representation a plan view of a circuit board for the light diodes of the ring lamp of FIG. 5;

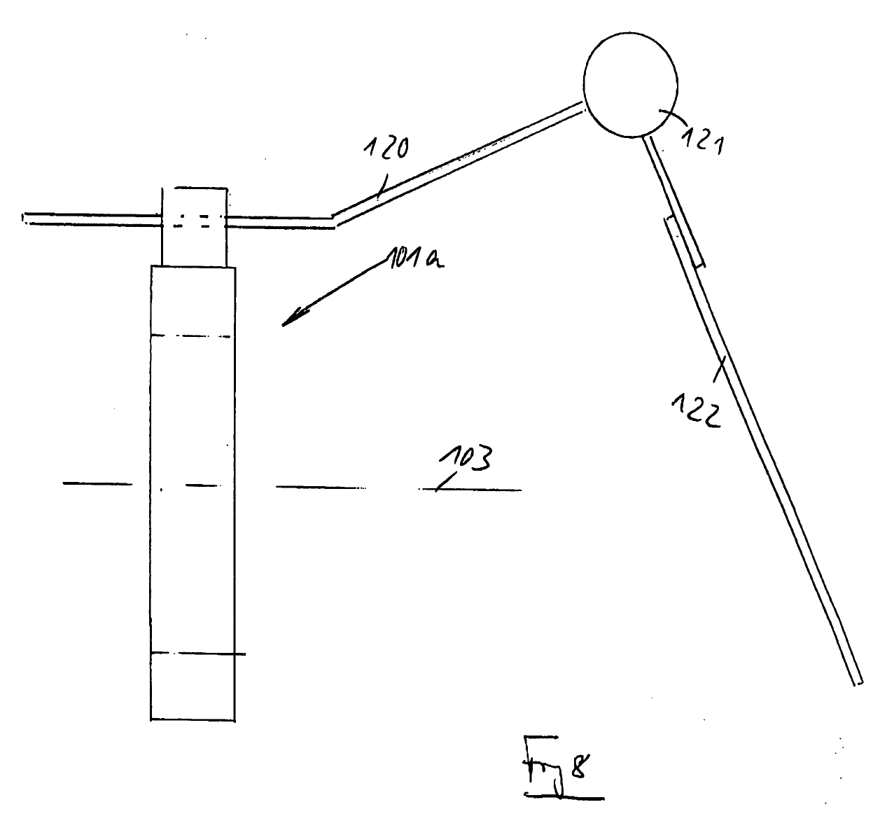

FIG. 7 in a simplified representation a partial section through the ring lamp of FIG. 5;

FIG. 8 in a simplified representation a ring lamp according to the invention with a lens support.

Within FIG. 1 a ring lamp is shown which is generally designated by 1, and which by means of a supporting ring 2 is fastened to a lens (not shown) of a camera, such as a digital camera (also not shown) so that the ring lamp 1 with its ring axis 3 is coaxially arranged in view of the optical axis of the lens.

An the front side of the support ring 2 a plurality of LEDs 4 is provided in an arrangement as a ring of three rows, which means in the form of three concentric circles around the ring axis 3.

Triggering the light diodes 4 is performed by a control and supply unit 5 which as the current or supply source also for the ring lamp 1 comprises a battery 6 as well a control and regulation electronic unit 7. Furthermore, functional elements are provided at the control and supply unit 5 or alternatively on the casing 8 of this unit, for example, a socket 9 for joining a connector cable 10 in order to connect the ring lamp 1 with the portable control and supply unit 5, manually operated functional switches 11 and push-buttons 12 as well control lamps 13.

The LEDs 4 are diodes with high illumination power of at least 3000 mcd, namely LEDs emitting white light or slightly blue light, whereby the sensibility also for the human eye with slightly blue light is many times higher than for genuine white light.

With the embodiment shown in FIG. 1 the three rings can be individually triggered from the LEDs 4 which means that these rings can be switched on and off independent from each other via the control unit 5, or can be controlled concerning their light intensity by dimmering means.

The LEDs 4 which are switched in parallel in each annular arrangement, are supplied by the control and supply unit 5 with constant or controlled voltage, which f.e. in the undimmered condition can be 3,6 volt. The voltage control is obtained for example by pulse width controlling and subsequent rectifying within the control and regulation electronic unit 7. Also other processes for controlling the supply voltage of the LEDs 4 can be used.

In addition, the control and supply unit 5 or alternatively it's control and regulation electronic unit 7 has a timer function which allows switching-off of the ring lamp 1 automatically after a time period determined by this timer function so that switching the annular lamp 1 on again only will be possible by operating the push button 12.

Basically, there is the possibility to design the LEDs 4 in such a manner that they emit light in different colours in order to obtain altogether a shade for the light emitted by the ring lamp 1, which shade with the corresponding special range of use, for which the ring lamp 1 is intended or used, a special optimum contrast, etc. will be guaranted.

By arranging the LEDs in several rings it is possible to use for each ring LEDs 4 of different colour, whereby then for example within one arrangement of three concentric rings the LEDs 4 in a first ring emit red light, the LEDs 4 in the second ring emit yellow light, and the LEDs within the third ring emit blue light so that by controlling the light intensity of these rings as well white light as also coloured light in most different colours can be obtained.

Furthermore, there is the possibility to design the ring lamp 1 so that the LEDs 4 are sub-divided into several sectors or quadrants, as this is shown in FIG. 1 by A-D, whereby the LEDs 4 of each sector can be individually triggered.

The LEDs 4 preferably are provided on an annular circuit board, and are preferably formed within an annular groove, with the annular axis 3 concentrically embracing the recess 14 in such a manner that the LEDs 4 do not extend beyond the annular groove type recess 14.

FIG. 2 shows the circuit board 15 in a simplified partial representation. On this circuit board three circular, concentric conductor paths 16, 17 and 18 are formed with radially inwardly resp. outwardly extending contact surfaces 19 or 20 so that each LED 4 with the two terminals is connected with a contact surface 19 and a contact surface 20 of two adjacent conductor paths, and is arranged tangential or substantially tangential to a theoretical circular line around the ring axis 3 with respect to the plane including both terminals.

FIG. 3 as a further embodiment shows a ring lamp la with which the support ring 2 at its front side is provided with a thread 21 for a focussing ring 22, which at its inner side forms a conical contact surface 23 surrounding axis 3 in such a manner that the inner diameter of this focussing ring 22 tapers towards that side arranged distant from the circuit board 15. The contact surface 23 interacts with the LEDs 4 in such a manner that when rotating the focussing ring 22 in one direction the LEDs 4 will be increasingly tilted towards the axis 3, as is shown in FIG. 3 by arrow E, whereas, when rotating the focussing ring 22 in the other direction, which means moving the ring away from the circuit board 15 the LEDs 4 will raise again, which means will tilt away from the axis 3 as shown by arrow F. In order to allow or support this movement of tilting away or backwards, between each LED 4 and the circuit board 15 a restoring element 24 is provided, which is made of elastic material. This restoring element 24 for example is formed by a flexible ring common to all LEDs 4, or is formed by a flexible ring segment. With a ring lamp 1a of this type the LEDs 4 are provided in arranging a single individual ring only.

FIG. 4 in a simplified representation and in lateral view shows a ring lamp 1b, which differs from the ring lamp 1 substantially in that the supporting ring 1 is provided with a support 25 for a mirror 26, which for example can be inserted into the mouth of a patient to an extent that by means of the mirror 26 also images from the distal tooth areas etc. will be possible.

Within FIGS. 5-8 a ring lamp 101 is shown, which can be fastened by means of a support ring or an annular casing 102 on a lens (not shown) of a camera (also not shown), for example a digital camera, in such a manner that the ring axis 103 of ring lamp 101 is coaxially arranged in view of the optical axis of the lens. Within support ring 102 a ring-like board 104 of highly flexible and elastic plastics or board material is arranged, on which a plurality of light diodes 105 are arranged in a ring-like structure. Furthermore, conductors 106 are formed on the board adjacent the inner edge of said ring-lake board, by means of which the light diodes 105 are electrically connected with their supply means, and which are provided with an exterior connector 106′.

The light diodes 105 are arranged on the same side of the board 104, namely at the front side of the ring lamp 101 or alternatively the supporting ring, or alternatively the ring-lake casing 102 of said ring lamp. Starting from the outer rim the ring-like board 104 is provided with a plurality of V-shaped notches 107 which widen outwardly in a radial direction in such a manner that between two light diodes 105 one recess 107 each is provided.

As especially shown in FIG. 7 the casing 102 is made of several parts and consists of an inner ring or casing element 102′, by means of which the ring lamp 101 is fastened to the lens of the camera, and an outer casing or ring element 102″ which is movable along a predetermined axial distance, namely parallel to the ring axis 103 relative to the inner ring element 102 (twin arrow A of FIG. 7), for example in such a manner that the outer ring element 102″ is guided by means of a thread on a complementary thread of the inner ring element 102′.

With the interior edge 104′ the board 104 is clamped or fastened to an inner ring element 102′. With its exterior edge 104″ the board 104 rests on a support or stop 108 of the exterior ring element 102″. With the shown embodiment said support 108 is formed by an annular surface arranged in a plane vertical to the annular axis 103 of an annular recess 109, into which the board extends radially with its edge 104″.

By moving the outer ring element 102″ axially relative to the inner ring element 102′ the inclination of the board segments 104″ changes caused by elastically deforming the board 104 resp. the plate segments 104′″ formed between the recesses 107, and thus of the light diodes 105 with respect to a plane extending vertically to the ring axis 103 so that by moving the outer ring element 102″ relative to the inner ring element 102′ it is possible to change the position of the focus within which the light beams 110 leaving the light diode 105 are concentrated. Focussing the light beams 110 by means of this structure is possible in a very simple manner.

Triggering the light diodes 105 is performed by a control and supply unit 111 which as the current or supply voltage source has a battery 112 and also a control and regulating electronic system 113. Furthermore, the control and supply unit 111 or the casing 114 of said unit is provided with functional elements, for example a socket 115 for receiving a connector cable 116, by means of which the ring lamp 101 is connected with the portable control and supply unit 111, several manually operated functional switches 117 and push-buttons 118.

The light diodes 105 are diodes with high brightness of at least 3000 mcd, namely light diodes emitting white light or weak blue light, whereby the sensitivity also for the human eye with weak blue light is many times higher that with genuine white light. The light diodes 105 preferably are connected parallel with each other, and are supplied by the control and supply unit 111 with constant or controlled voltage, for example in the undimmed condition with a voltage of 3,6 volt. Controlling the voltage may be performed by pulse width control and by subsequent rectifying within the control and regulation electronic 107. Also other processes for controlling the supply voltage of the light diodes 105 can be used. The control and supply unit 111 in addition has a timer function which allows to switch-off the control lamp 101 after a time period determined by the timer function so that the ring lamp 101 can be switched on again only if for example a push-button 118 is operated.

Triggering also can be effected in such a manner that the ring lamp 101 operates as a flash-light, which means that the light diodes 105 can be triggered shortly for emitting flash-light pulses but also in combination for emitting continuous light and flash-light, and controlled by means of a flash-light contact of the camera whereby the operating voltage of the light diode is increased over a short period when flash-lights are emitted.

FIG. 8 in its simplified representation shows a ring lamp 101a, which—not necessarily—is formed just as the ring lamp 101. One end of arm 120 is removably attached to the ring lamp 101a or to its casing 102a which arm extends away from the front side of the ring lamp 102a and with its longitudinal extension is parallel or substantially parallel to the ring axis 103. On the free end of arm 120 a plate-lake lens carrier 122 is fastened by means of a hinge connection 121 in such a manner that said lens carrier 122 is arranged at least with a partial area within axis 103a and thus, within the optical axis of the lens of a camera provided with a ring lamp 101a. By means of the hinge 121 the lens carrier is tiltable. The lens carrier 122 preferably is made from glass.

Above, the invention has been described by embodiments. The expert realizes that numerous alterations and variations are possible without leaving the inventive idea.

For example, it is possible to design the described ring lamps 1, 1a and 1b so that they or alternatively their LEDs similar to flash-lights will emit flash-light pulses in short intervals, namely controlled by a flash-light contact of a camera which is connected with a control cable (not shown) with a corresponding terminal of the control and regulation electronic 7. When triggering the LEDs 4 by short pulses said LEDs can be operated with higher voltage in order to obtain a higher amount of light to be emitted.

Furthermore, it is also possible to trigger the LEDs in such a manner that with the ring lamp 1, 1a or 1b switched on, which means with activated LEDs 4, for example controlled by the flash-light contact of a camera a short-time increase of the operation voltage of these LEDs or of some of the LEDs is effected in order to allow the user to adjust the camera with continuous light, and for taking the picture to obtain a higher light enery in the form of a short-time light flash.

Alternatively, it is possible to subdivide the arrangement of the LEDs 4 concerning their function in such a manner that a group of LEDs 4 can be operated for emitting the continuous light and a further group of LEDs 4 for emitting an increased amount of light over a short period by increasing the supplied operating voltage over a short period, or for emitting a flash-light with a short-time voltage pulse.

### LIST OF REFERENCE NUMERALS

1, 1a, 1b ring lamp

2 supporting ring

3 annular axis

4 LED

5 control and supply unit

6 battery

7 control and regulation electronic

8 casing

9 socket

10 connector

11 switch

12 push button

13 control lamp

14 recess

15 circuit board

16, 17, 18 circuit conductor

19, 20 contact surface

21 thread

22 focussing ring

23 contact surface

24 restoring element

25 holder

26 mirror

101, 101a ring lamp

102, 102a casing or support ring

102′, 102″ annular portion

103, 103a annular axis

104 board

104′, 104″ edge of the board

104′″ board segment

105 light diode

106 conductor

106′ terminal

107 cut-out or recess

108 support

109 groove-like recess

110 light beam

111 control and supply unit

112 battery

113 control and regulation electronic

114 casing

115 socket

116 connector

117 switch

118 push-button

120 arm

121 hinge

122 lens carrier

1. Ring lamp to be used on a lens of a camera, especially a digital camera, comprising a support (2) fastened on the lens or the casing (102), and a light source, characterized in that the light source is formed by a plurality of light emitting diodes (4, 105).

2. Ring lamp according to claim 1, wherein the light emitting diodes are single LEDs (4, 105).

3. Ring lamp according to claim 1 or 2, comprising an annular circuit board (15) for the light emitting diodes (4, 105).

4. Ring lamp accoding to any one of the preceding claims, wherein the light emitting diodes (4, 105) are arranged in at least two concentric rings.

5. Ring lamp according to any one of the preceding claims, wherein a control and regulation unit (5, 111) is provided for triggering the light emitting diodes (4).

6. Ring lamp according to claim 5, wherein the light emitting diodes (4, 105) are arranged in groups which can be individually triggered by the control and regulation unit (5, 111).

7. Ring lamp according to claim 5 or 6, wherein the annular structures of the light emitting diodes (4, 105) can be individually triggered.

8. Ring lamp according to any one of the preceding claims, wherein the groups of light emitting diodes (4, 105), which can be individually triggered, are arranged in ring sectors.

9. Ring lamp according to any one of the preceding claims, wherein the light emitting diodes (4) are adjustable by means of a focussing ring (22) relative to a ring axis (3).

10. Ring lamp according to any one of the preceding claims, wherein at least two groups of light emitting diodes (4, 105) are provided, which groups of diodes emit light of different colour or wavelength.

11. Ring lamp according to any one of the preceding claims, wherein a control and regulation electronic is provided within the control and supply unit (5, 111) for controlling the light intensity of the light emitting diodes (4, 105), and/or with a timer function for switching-off the ring lamp (1, 101, 101a) after a predetermined time period.

12. Ring lamp according to any one of the preceding claims, wherein a mirror (26) is fastened to a holder (25) so that the mirror (26) is arranged staggered in the direction of the ring axis (3) in view of the light source.

13. Ring lamp according to claim 12, wherein the plane of the mirror (26) forms an angle with the ring axis.

14. Ring lamp according to any one of the preceding claims, wherein at least some of the diodes (4, 105) emitting light and forming the light sources can be triggered as pulses for generating a flash of light.

15. Ring lamp according to any one of the preceding claims, wherein at least some of the diodes (4) forming the light source and emitting light can be triggered in their activated condition by shortly increasing the operating voltage for a short-time increase of the emitted light amount.

16. Ring lamp according to any one of the preceding claims, wherein the holding structure is at least a ring-type board (104) provided at least along its edge (104′, 104″) with a plurality of cut-outs (107) opening towards this edge, that the board (104) along its edges (104′, 104″) is supported on one of the casing portions (102′, 102″) each, and that the casing (102) comprises at least two casing portions (102′, 102″) which are movable in the axial direction (103) of the ring lamp relative to each other.

17. Ring lamp according to claim 16, wherein the at least one board (104) with one edge (104′, 104″) is clamped or fastened onto a casing portion (102′, 102″) and on the other edge (104″, 104′) rests against a stop (108) of the other casing portion (102″, 102′).

18. Ring lamp according to claim 16 or 17, wherein the casing portions (102′, 102″) are connected with each other by means of inter-engaging threads.

19. Ring lamp according to any one of the preceding claims, wherein at least the one board (104) by said cut-outs (107) is sub-divided into a plurality of segments.

20. Ring lamp according to claim 19, wherein the board segments are connected with each other by means of a ring-shaped material section.

21. Ring lamp according to any one of the preceding claims, wherein one light emitting diode (105) each or a group of such diodes is provided between two cut-outs (107).

22. Ring lamp according to anyone of the preceeding claims, wherein at least one board (104) is made of highly flexible and elastic board material.

23. Ring lamp for being used on a lens of a camera, especially a digital camera, comprising a ring-like casing (102a), which can be fastened to a lens, and an annular light source formed by a plurality of light emitting diodes (105), characterized in that a support arm (120) is provided extending beyond a front side of the ring lamp and supporting a board-like lens carrier (121) on its end distant from the casing (102a).

24. Ring lamp according to claim 23, wherein the lens carrier (122) is connected with the arm (120) by means of a hinge (121).

25. Ring lamp according to claim 23 or 24, wherein the arm (120) is connected with the casing (102a) by means of a hinge (121).
